(19) United States
(12) Patent Application Publication
(10) Pub. No.: US 2008/0303630 A1
(43) Pub. Date: Dec. 11, 2008

(54) DigiKey and DigiLock

(76) Inventor: Danilo Jose Martinez, Orlando, FL (US)

Correspondence Address: Danilo Martinez, 14311 Lord Barclay Dr., Orlando, FL, 32837, US

(21) Appl. No.: 11/759,146

(22) Filed: Jun. 6, 2007

(51) Int. Cl. G06F 7/00

(52) U.S. Cl. 340/5.7; 70/266

(57) ABSTRACT

The present invention discloses an improvement in conventional lock and key mechanical fastening devices. This complete electronic security system utilizes a radio standard and communications protocol such as bluetooth, asymmetric cryptography encryption algorithms for authentication, confidentiality and non-repudiation purposes such as GPG, and a magnetic lock mechanism.

A magnetic lock is mounted on the frame and can be set between locked and unlocked positions. The lock mechanism selectively blocks and unblocks the access opening depending on the authenication communication provided by both the emmiter (I.E. Cell Phone) and the magnetic lock. The receiving device (GPG de-encryptor) will be embedded inside the lock itself and will be responsible for verifying message integrity and origin by calculating the hash value of the received message and comparing it against the decoded signature (the original hash). If the hash from the emitter (IE Cell Phone) and the hash on the receiver (IE Magnetic Lock) side do not match, then the received message is not identical to the message which the sender “signed”, or the sender's identity is wrong, thus the magnetic lock device will not open, and an signal can be emitted via SMS thus allerting of an anomality.

The emmiter (I.E. Cell Phone) will be provided with a software code for it to encrypt the message signaling a lock/unlock status to the magnetic lock using his private key, then a second encryption is performed using the receiver's public key thus achieving authentication, non-repudiation, and confidentiality.

The present invention relates to a magnetic lock mechanism comprising a magnetic lock, radio protocols and asymmetric cryptography encryption algorithms for authentication, confidentiality and non-repudiation. In particular, this invention concerns domestic doors, industrial doors, car doors, and so on, to effectively prevent theft.

### BACKGROUND OF THE INVENTION

Doors are used for partitioning spaces, such as inside and outside of buildings, rooms in a building, and hotel rooms. Such doors are often provided with locks for the purpose of protection of privacy or security.

Some types of the doors with locks for protecting rooms are openable by simply rotating a handle or knob on the doors from inside the room, but requires releasing of the locks for opening from outside the rooms for security. Some types of the locks are released by using keys or magnetic cards, and some other types are released by pressing buttons or turning a dial in predetermined directions, in accordance with a predetermined secrete code, which the opener of the door must memorize. When the lock is released in such a way, the door is openable by rotating and pulling or pushing the handle or knob.

Recently, advances in radio fradio standard and communications protocol primarily designed for low power consumption, with a short range (power class dependent: 1 metre, 10 metres, 100 metres) based around low-cost transceiver microchips in each device, can permit another easier more convenient way for the end-user to lock/unlock/control/supervise a door.

The advantage of using a electronic key device, that can encode by way of an asymmetric cryptography encryption algorithms for authentication, confidentiality and non-repudiation, is that this software can be installed in any emitter with blue tooth capability (I.E. Cell Phone). That way the end-user does not have to burden himself with carrying whatever amount of keys to open his home, car, and/or office doors. Apart from being practible, the main objective of the project is for it to be durable which can make them valuable in a high-traffic office environment where electronic authentication is necessary. Furthermore, by using an electronic signal instead of an actual metal key to open a door, will be environmentally friendly as metal will not be needed for key production and more keys will not be produced, which are not biodegradable and almost never recycled.

By utilizing a public-key, private key mechanism utilizing a cyhper key of 128 bit will ensure military grade protection to common households, cars, and any other door alike.

The magnetic lock will require a constant power source at around 3 watts, which would cause the power drain of the lock to be not substantial, compared to a conventional lightbulb (around 60 watts).

When the emitter is battery operated (I.E. Cell Phone) there has always been the problem that when the batteries become weak so does the resulting key will not perform its duty of locking/unlocking. That is why an exceptional mechanism is provided, utilizing a regular key-lock, or touch pad code mechanism.

This complete electronic security system also permits the end user to monitor activity of the doors, by means of XML type formats. A record of locks/unlocks events can be recovered by connecting the locking device to any computer of the last 300 events will be displayed. Also, will be a means by which a emmiter device can query (consult) the lock to see in what state it is in, and change it to the desired state if necessary.

### SUMMARY OF THE INVENTION

In view of the foregoing, it should be apparent that a need still exists for a locking device technology that avoids the problems inherent in the prior systems. Accordingly, it is a primary object of the present invention to provide an improved key and lock mechanism which is of a simple, reliable, robust and reversible construction and use.

The apparatus (lock) comprises:

(a) a processing unit for authentication, confidentiality and non-repudiation between the lock and key; This lock will provide authorization based on an Access Control Lists (ACLs) located inside the firmware of the locking device. This will permit that all of the members of the family have a different key for entering the same door. Also, this will permit, in the event of a key to be lost, for a new one to be generated (causing the old key to be trashed away), without incurring the cost of replacing the lock.

(b) a magnetic lock is a simple locking device that consists of an electromagnet and armature plate. By attaching the electromagnet to the door frame and the armature plate to the door, a current passing through the electromagnet attracts the armature plate holding the door shut. The magnetic lock is generally placed on the inside of the door frame to prevent tampering. It is important to make sure the armature plate and the electromagnet align as closely as possible to ensure efficient operation.

The software side (emitter) comprises:

A public key encryption system which will provide confidentiality and authentication to the lock by means of an asymmetric cryptography encryption algorithms; a message which a emitter encrypts using the lock's public key can only be decrypted by the emitter's paired private key.

The processing unit is arranged to output a signal to the magnetical locking device indicative to an approved/denied authentication.

According to a further aspect of this invention there is provided a method of monitoring the state of a door. In the method:

(a) a sensor will determine the state of the lock;

It will be appreciated that with the devices (IE. Magnetic Lock) of this invention, or when performing the method also of this invention, a relatively minor modification to a known system allows enhanced reliability and safety, in use.

### BRIEF DESCRIPTION OF EXEMPLARY DRAWINGS

FIG. 1 is a schematic of the combination lock hardware that is used with relay (to open/close a door). The functionality of the DigiKey & DigiLock is implemented in software not in the lock hardware device.

DIAGRAM A is a perspective view of the components necessary to activate the whole DigiKey & DigiLock process. (A) The smart phone, laptop, PC PDA or any device with personal computer like functionality with Bluetooth/WiFi capability. DigiKey part of the software is installed into this device. (B-C) Bluetooth/WiFi aware device attached to lock. The DigiLock part of the software is installed into this device. (D) Automatic lock device hardware.

The above and other features and advantages of the present invention are hereinafter described in the following detailed description of illustrative embodiments to be read in conjunction with the accompanying drawing and figures, wherein like reference numeral are used to identify the same or similar system part and/or method step in the similar view and:

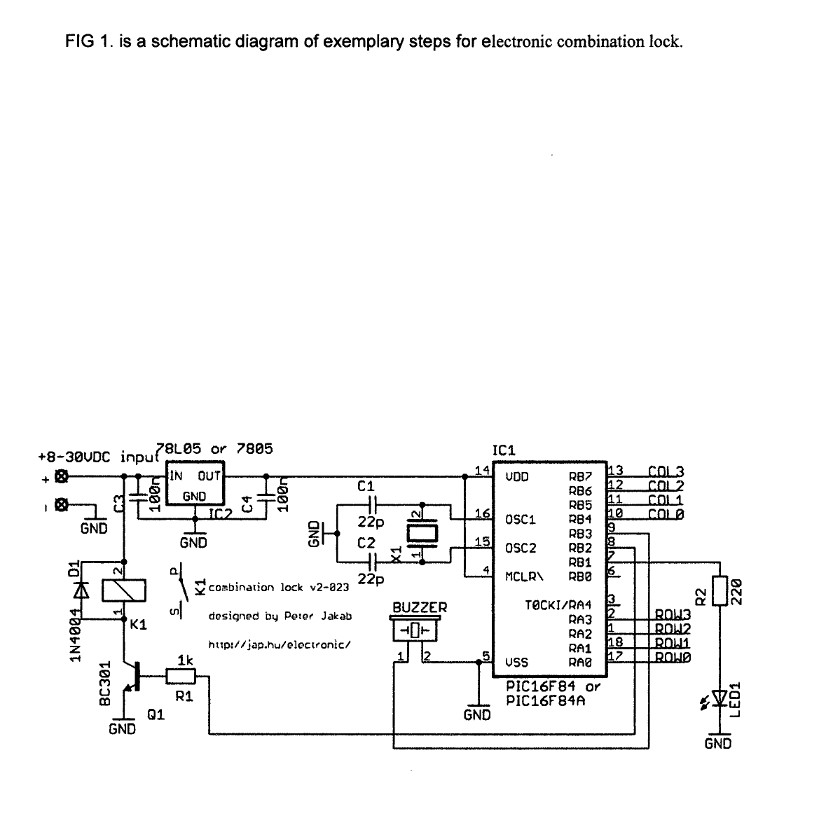

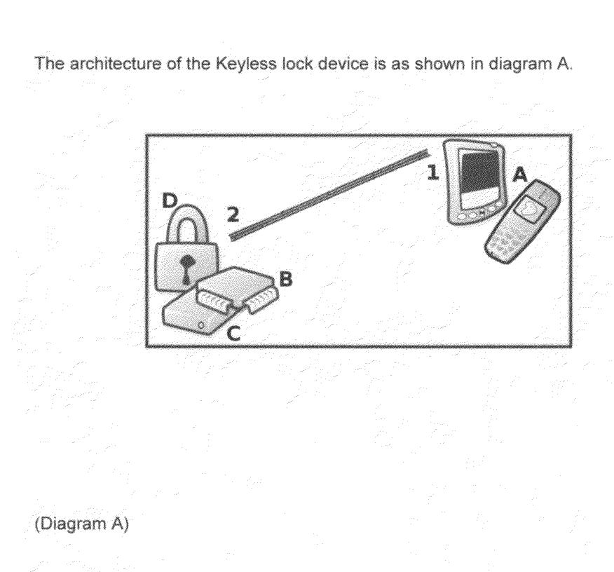

FIG. 1. is a schematic diagram of exemplary steps for electronic combination lock.

Other aspects and features of the present invention will be more fully apparent from the detailed description that follows.

### DETAILED DESCRIPTION OF EXEMPLARY EMBODIMENTS

Devices used for the Keyless Lock system are as follows:
1) Automatic lock device
2) Bluetooth/WiFi aware device attached to lock
3) Smart Phone, Laptop, PC, PDA or any device with personal computer like functionality with Bluetooth/WiFi capability

The architecture of the Keyless lock device is as shown in diagram A.

### Devices

The devices involved in the architecture of the Keyless lock device are:

### A) PDA or SmartPhone (Java[1] Capable):

These devices initiate the communication cycle. They contain a Java-based software developed to interact with bluetooth/WiFi transceivers specially programmed for the Keyless device as specified in the JSR-82/JSR-46 Java API. The software establishes a paired connection to an specific Keyless lock device set up in the installation stage.

### B) Embeded Processor:

Embeded programmable processor for the Keyless system based on ARM Cortex-M1. These processor runs on 32-bit RISC technology. It represents the central unit for processing the data coming from the outside and its attached to (C) Flash memory unit.

### C) Flash Memory Unit:

The Flash Memory Unit represents an storage device which has an embedded GNU/Linux flavor to provide the logic behind the Keyless system. This OS contains a bluetooth based server which will accept (accordingly to security settings) connections coming from (A) external devices. This process will be explained further ahead.

### D) Electromagnetic Door Lock:

This lock represents the most important device on the Keyless system. This electromagnetic door lock is designed to open/close its relay only on electric strikes coming from the embedded circuit next to it. From a security point of view and other practical reasons this lock should have association with the Keyless system another backup/auxiliary traditional way of opening/closing a lock via a key and/or other mechanical way. FIG. 1.

### Connections

Connections consist of packet transmissions based on the Bluetooth standard protocol or WiFi standard (802.11x) over a double-secured channel. The communication cycle is initiated at (1) in Diagram A from an SmartPhone or PDA device and is received by (2).

Secure Bluetooth/WiFi communications requires a pairing process between connecting devices so they can provide some kind of security in the transactions they are about to start.

It will use a standard cipher protocol for codings data in Wi-Fi like the WEP, WAP2 and WPA so the that transmitted information will be protected confidentiality wise. For bluetooth devices we will utilize security using Link Manager Protocol (LMP) or using the E0 cipher protocol. This protocol uses security mechanisms before setting up the communication channel through authentication. Once established a secure channel and safe connection, it is now where the second level of security (public-key private-key) comes into play.

As the Keyless device is a security artifact, some measures on security should be added to the communication process. A second security layer was built to prevent possible break-in attempts from outsider devices. This security layer provides a GPG environment for both the initiating device and the receiver device (Keyless device) this GPG environment provides asymmetric-encryption through DSA/Elgamal (2048 bit min.) digital keys that will be used to cipher information exchange between both devices. The communication protocol should be now closed tight to hacking and craking situations. All primary data will be passed in an encrypted way.

In the Keyless device case, this process is done automatically in the setup process. As the Keyless device Bluetooth receiver will always be in undiscoverable mode, no other bluetooth-capable devices will be aware of its presence.

The first two levels of security establishes a reliable and safe connection and transmission of the package that indicated to the lock the action to follow. This package is made up of following the data:

Identification of the device: identifier that corresponds to a unique number for the emitting dispotivo. (i.e. MAC) Time/date of the request: format “timestamp”.

Key of Authorization: a third mechanism of security to help prevent theft in case of a lost or stolen digi-key emitter, will be to established by means of a key “PIN” that the user will have to type in order for an action to take place. This PIN will have the same functionality of a “PIN” of a “ATM: Automated Teller Machine”

Action To take: Action that the digi-lock will have to execute once introduced the correct PIN number. These could be: open lock, close lock.

Once devices are paired, the password required by them to interact with each other will be sent automatically for each session unless the password is changed by the owner. After passwords are sent, then a secure channel is established to let the data go from (1) to (2) securely. The data received by (2) gets validates and processed accordingly.

Once the cyphered package is received, it is necessary that (2) uncypher utilizing a asymmetric cryptography (Public-key cryptography) mechanism such as GPG. If a message which a emitter encrypts using the lock's public key is decrypted by the emitter's paired private key, then the user will have to enter the valid PIN number. (2) will then check an access list (List Access) that will contain the users with permission to access the lock.

If the validation process returns a valid state, the command set by (1) is processed and the keyless mechanism is then activated to open or close the lock.

“digikey and digilock” filed on ______, which is incorporated herein by reference:

We claim:

1. A complete electronic security solution structure comprising: a magnetic lock, said magnetic lock unit is to be mounted on any door; the lock mechanism will prevent from opening the door when the lock mechanism is in the locked position; and the lock mechanism including and at least one magnetically activated locking element movable between locked and unlocked positions; the lock mechanism also including a mechanically activated locking element movable between locked and unlocked positions; and the magnetically activated locking element being movable in a direction substantially opposite than the direction of movement for the mechanically activated locking element. A processing unit installed in the lock will process the signal sources from the emitter and activate the magnetically activated locking element to open if an authentication process is accepted;

2. The complete electronic security solution as claimed in claim 1, further comprising a electronic key software to lock or unlock said lock. This electronic key, using an asymmetric cryptography encryption algorithms, will be contain a cyphered key utilized for authentication, confidentiality and non-repudiation.

3. The complete electronic security solution as claimed in claim 1, wherein the mechanically activated locking element is separated from the magnetically activated locking element and is independently operable. Thus permitting the end user utilize a regular key or key pad to lock or unlock said lock manually or by way of a battery operated lock, if needed.

4. The complete electronic security solution as claimed in claim 1, wherein the data sent from the emmiter will be a stream comprise encrypted binary data. This data string comprise a 128 bit binary codes based on the RSA asymmetric key algorithm.

5. The complete electronic security solution as claimed in claim 1, wherein processing unit includes a random number generator which aids in the decyphering of the public-key private-key scheme.

6. The complete electronic security solution as claimed in claim 1, wherein the processing unit includes an interface unit which receives the generated code and converts that code to a format for letting the locking device know when to open/close lock.

7. Control apparatus as claimed in claim 1, wherein the first sensor comprises a first switch which is closed so long as the electrically-released latch is in its door-locked position. operation of the magnetic lock being controlled by the processing unit.

8. The complete electronic security solution as claimed in claim 1, where in the case of loss of power to the lock, the fail closed mechanism will activate in which the device is locked upon power loss. This will permit the end-user by manual means open the door.

9. The complete electronic security solution as claimed in claim 1, wherein a sensor senses the position of the door lock (to be open or closed).
